(19) United States
(12) Patent Application Publication
(10) Pub. No.: US 2021/0035444 A1
(43) Pub. Date: Feb. 4, 2021

(54) SELF-CONTAINED, INTEGRATED AD-HOC TRANSMISSION SYSTEM AND METHOD FOR CAPTURING IMAGES OF DRIVERS WHILE TEXTING BY LAW ENFORCEMENT PERSONNEL IN A LAW ENFORCEMENT VEHICLE

(71) Applicant: Jason Goucher, Pelham, NH (US)

(72) Inventor: Jason Goucher, Pelham, NH (US)

(21) Appl. No.: 16/943,402

(22) Filed: Jul. 30, 2020

Related U.S. Application Data
(60) Provisional application No. 62/880,920, filed on Jul. 31, 2019.

(51) Int. Cl. G08G 1/017; H04N 7/18; H04N 5/232

(52) U.S. Cl. CPC G08G 1/0175; H04N 5/23206; H04N 7/185

(57) ABSTRACT

A self-contained, integrated ad-hoc transmission system for capturing images of drivers while texting by law enforcement personnel in a law enforcement vehicle, the system includes one or more dumb cameras mounted inside the law enforcement vehicle, a plurality of user-activated switches, and a computer subsystem coupled to the one or more dumb cameras by one or more lines and coupled to a plurality of user-activated switches. The computer subsystem includes at least one processor and a storage device and is configured to safely enable the law enforcement personnel inside the law enforcement vehicle to capture images and/or videos of drivers while texting by activating one of the plurality of user-activated switches to enable one or more of the one or more dumb cameras to capture the images and/or videos of drivers while texting. The processor is further configured to store the captured images and/or videos on the storage device and organize the captured images and/or videos by date and time for ad-hoc transmission to a computer subsystem of a law enforcement entity.

### RELATED APPLICATIONS

This application claims the benefit of and priority to U.S. Provisional Application Ser. No. 62/880,920 filed Jul. 31, 2019, under 35 U.S.C. §§ 119, 120, 363, 365, and 37 C.F.R. § 1.55 and § 1.78, which are incorporated herein by this reference.

### FIELD OF THE INVENTION

This invention relates to a self-contained, integrated ad-hoc transmission system and method for capturing images of drivers while texting by law enforcement personnel in a law enforcement vehicle.

### BACKGROUND OF THE INVENTION

Texting while driving is believed to kill about 14 people per day in the United States. Law enforcement personnel have indicated there is no no safe, single, integrated, portable unit or system that may be used in a law enforcement vehicle to prove the actions of drivers while texting and driving. As a result, law enforcement personnel typically do not issue citations to drivers that are texting while driving. With the increased use of smartphones in vehicles, the problem is growing at an alarming rate. Both local and state law enforcement personnel have expressed a desperate need to overcome the evidence issues they face when issuing a citation for drivers that are texting while driving and to do so in a manner which also keeps the law enforcement safe while capturing images of drivers while texting. Recently enacted laws in many states associated with the use of mobile phone while driving may also need the evidence provided by law enforcement personnel to enforce the new laws.

One distracted driving violation detecting and reporting system is disclosed in U.S. Publication No. 2015/0363650, incorporated by reference herein. The '650 patent application discloses a system which utilizes a hand-held camera and a system which automatically processes the images taken of a license plate to an offsite facility. The '650 patent application relies on an automated process, taking pictures of a license plate, and then sending a ticket to the owner of the vehicle or replying back to an officer that the picture taken was legible. The '650 patent application requires an offsite server, allows for civilian use, and is not mounted in or to a vehicle.

U.S. Publication No. 2016/0006922 for a vehicle camera system, incorporated by reference herein, teaches a cumbersome and complex camera system that compiles information from multiple components. The system requires a mobile communication device, e.g., a smart mobile phone, to operate and relies on a communication network and server to transfer data from a camera. The camera system is not mounted in a law enforcement vehicle and does not require the device to be operated by law enforcement personnel.

Other conventional smart cameras are known, e.g., as disclosed in U.S. Pat. No. 9,262,800, often referred to as the GoPro. However, such smart cameras do not have any way to track or time stamp images of drivers while texting in order for law enforcement personnel to issue a citation.

Thus, there is a need for a self-contained and integrated system which is mounted in a law enforcement vehicle, is only operated by law enforcement personnel, allows law enforcement personnel to safely capture images of drivers while texting, does not utilize a mobile communication device, or a communications network and server, and provides for ad-hoc transfer of the data captured organized by date and time to a law enforcement computer subsystem.

### SUMMARY OF THE INVENTION

In one aspect, a self-contained, integrated ad-hoc transmission system for capturing images of drivers while texting by law enforcement personnel in a law enforcement vehicle is featured. The system includes one or more dumb cameras mounted inside the law enforcement vehicle, a plurality of user-activated switches, and a computer subsystem coupled to the one or more dumb cameras by one or more lines and coupled to a plurality of user-activated switches. The computer subsystem includes at least one processor and a storage device and is configured to safely enable the law enforcement personnel inside the law enforcement vehicle to capture images and/or videos of drivers while texting by activating one of the plurality of user-activated switches to enable one or more of the one or more dumb cameras to capture the images and/or videos of drivers while texting. The processor is further configured to store the captured images and/or videos on the storage device and organize the captured images and/or videos by date and time for ad-hoc transmission to a computer subsystem of a law enforcement entity.

In one embodiment, the one or more dumb cameras mounted in the law enforcement vehicle may include at least one dumb camera mounted on a driver side of a law enforcement vehicle and at least one dumb camera mounted on a passenger side of a law enforcement vehicle. The plurality of user-activated switches may include a first switch to enable the at least one dumb camera mounted on the driver side of the law enforcement vehicle to capture the images and/or videos of drivers while texting located proximate the driver side of the law enforcement vehicle and a second switch to enable the at least one dumb camera mounted on the passenger side of the windshield to capture the images and/or videos of drivers while texting proximate the passenger side of the law enforcement vehicle. The ad-hoc transmission may be to a portable storage device. The ad-hoc transmission may be to a computer subsystem located in the law enforcement vehicle. The ad-hoc transmission may include one or more of Bluetooth or internal wireless transmission. The computer subsystem may be configured as one of: a single board computer system, a micro-computer system(s), a miniature personal computer, or a miniature personal computer board. The computer subsystem may include the one or more processors, the storage device, and an operating system. The operating system may include one or more of Linux, and Unix, and Raspian. The computer subsystem coupled to the one or more dumb cameras by the one or more lines may include the Raspberry Pi computer subsystem coupled to a first ribbon cable, the first ribbon cable coupled to a first HDMI ribbon adapter, the first HDMI ribbon adapter coupled to one end of an HDMI, a second HDMI ribbon adapter coupled to another end of the HDMI cable, and a second ribbon cable coupled to one of the one or more dumb cameras. The one or more user-activated switches may include one or more a toggle switches. The one or more user-activated switches may include one or more joysticks for controlling the view of the one or more dumb cameras. The computer subsystem and the storage device may be enclosed in housing and the plurality of user-activated switches are mounted on the housing. The housing may be coupled to a computer mount located in the law enforcement vehicle.

In another aspect, a method for capturing images of drivers while texting by law enforcement personnel in a law enforcement vehicle is featured. The method includes providing one or more dumb cameras mounted inside the law enforcement vehicle to safely enabling law enforcement personnel located inside the law enforcement vehicle to capture images and/or videos of drivers while texting by activating one of a plurality of user-activated switches to enable one or more of the one or more dumb cameras to capture the images and/or videos of drivers while texting. The method includes storing the captured images and/or videos on a storage device and organizing the captured images and/or videos by date and time for ad-hoc transmission to a computer subsystem of a law enforcement entity.

In one embodiment, the method may further include mounting at least one or more of the dumb cameras on a driver side of the law enforcement vehicle and mounting at least one dumb camera on a passenger side of the law enforcement vehicle. The at least one or more dumb cameras mounted on the driver side of the law enforcement vehicle may enable capturing of images and/or videos of drivers while texting located proximate the driver side of the law enforcement vehicle and may enable at least one or more dumb cameras located on the passenger side of the law enforcement vehicle enabling capturing images and/or videos of drivers while texting proximate the passenger of the law enforcement vehicle. The ad-hoc transmission may be provided by a portable storage device. The ad-hoc transmission may be provided to a computer subsystem located in a law enforcement vehicle. The ad-hoc transmission may include one or more of Bluetooth or internal wireless transmission.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing the primary components of one example of the self-contained, integrated ad-hoc transmission system for capturing images of drivers while texting by law enforcement personnel in a law enforcement vehicle;

FIG. 2 shows an example of the system shown in FIG. 1 in place in a law enforcement vehicle;

FIG. 3 depicts an example of a driver texting while driving;

FIG. 4 shows an example of stored captured images and/or videos of drivers while texting captured by the system arranged in subfolders arranged by date and time;

FIGS. 5-7 show examples of the captured image and/or video for files stored the subfolders shown in FIG. 4;

FIGS. 8 and 9 show examples of a prototype of the system shown in FIG. 1;

FIG. 10 shows one example of a storage device which may be coupled to the system shown at least in FIGS. 1, 8 and 9 to provide for ad-hoc transmission of captured images and/or videos organized by date and time to a computer subsystem of a law enforcement entity;

FIG. 11 shows in further detail one example of the primary components of the computer subsystem shown in at least FIGS. 1, 8 and 9;

FIGS. 12, 13, and 14 shows in further detail one example of the primary components which may be used to couple the one or more lines shown in FIG. 1 to the computer subsystem and one or mom dumb cameras;

FIG. 15 shows in further detail examples of the plurality of user activated switches for the system shown in at least FIGS. 1, 8, and 9; and

FIG. 16 shows in further detail one example of the system shown in at least FIGS. 1, 8, and 9 in place in a law enforcement vehicle.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

As discussed in the Background section, one conventional distracted driving violation detecting and reporting system as disclosed in the '650 patent relies on a handheld camera which is not mounted in a law enforcement vehicle, allows for civilian use, and requires an offsite server.

The conventional camera system as disclosed in the '922 patent application is a cumbersome and complex system which requires a mobile communications device, such as a smart phone, and relies on a communication network and a server to transfer data from a camera mounted in the vehicle. The system of the '922 patent application is not mounted in a law enforcement vehicle and is not required to be operated by law enforcement personnel.

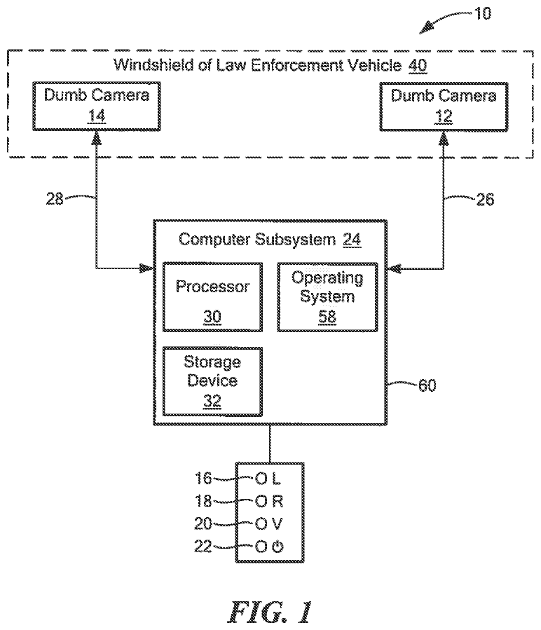

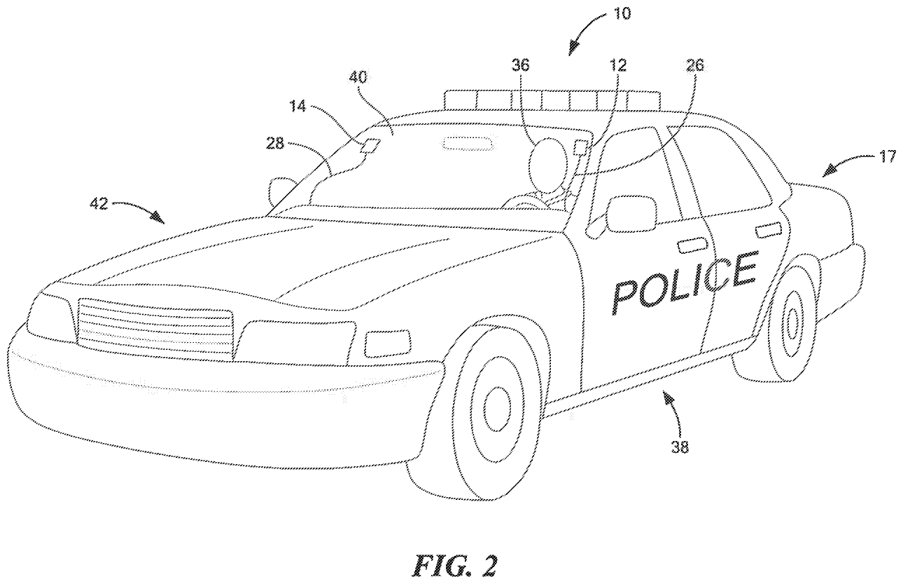

To overcome the problems associated with at least the conventional systems discussed in the Background section above and provide a independent and integrated system which can be mounted in a law enforcement vehicle, operated only by law enforcement personnel, and allow law enforcement personnel to safely capture images of drivers while texting, self-contained, integrated, ad-hoc transmission system 10, FIG. 1, and the method thereof for capturing images of drivers while texting by law enforcement personnel in a law enforcement vehicle of one or more embodiment of this invention includes one or more dumb cameras, e.g., dumb camera 12 and dumb camera 14, mounted inside a law enforcement vehicle. FIG. 2 shows on example of dumb camera 12 and dumb camera 14 mounted in this example to windshield 40 of law enforcement vehicle 17 as shown. In one example, the one or more dumb cameras may be a Raspberry Pi Cam model available from Sony UK Technology Centre, Pencoed Technology Park, Pencoed South Wales CF35 5 HZ.

System 10, FIG. 1, also includes a plurality of user activated switches, e.g., user activated switch 16, user activated switch 18, user activated switch 20, and user activated switch 22.

System 10 also includes computer subsystem 24 coupled to one or more dumb cameras 12, 14 by one or more lines, e.g., lines 26 and 28. Computer subsystem 24 is also coupled to the plurality of user activated switches 16, 18, 20, and 22, as discussed in further detail below. Computer subsystem 24 includes at least one processor, e.g., processor 30, e.g., an application-specific integrated circuit (ASIC), firmware, hardware, and/or software (including firmware, resident software, micro-code, and the like), or a combination of both hardware and software that may all be generally referred to herein as computer subsystem 24. Computer subsystem 24 also includes at least one storage device, e.g., storage device 32, e.g., random access memory (RAM), read-only memory (ROM), an erasable programmable read-only memory (EPROM or flash memory), or similar type computer readable storage medium or memory. The computer readable storage medium or memory may be any tangible medium that can contain or store one or more programs and/or data for use by or connection with the one or more processors 30 of computer subsystem 24.

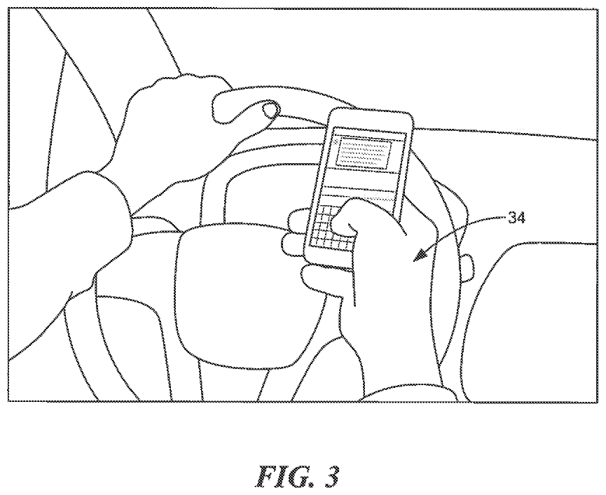

System 10 with computer subsystem 24 coupled to one or more dumb cameras 12 and 14 safely enables law enforcement personnel 36, FIG. 2, inside law enforcement vehicle 17 to capture images and/or videos of drivers while texting. As disclosed herein, “texting” may include texting messages, texting emails, typing, touching, or using a mobile device inside a vehicle that may violate one or more laws, procedures, or rules enforced by law enforcement personnel 36. FIG. 3 shows one example of driver 34 that is texting while driving.

In operation, law enforcement personnel 36, FIG. 2, inside law enforcement vehicle 17 activate one of the plurality of user activated switches 16, 18, or 20, FIG. 1, to enable one or more of dumb cameras 12, 14 to safely capture images and/or videos of drivers, e.g., driver 34, FIG. 3, while texting.

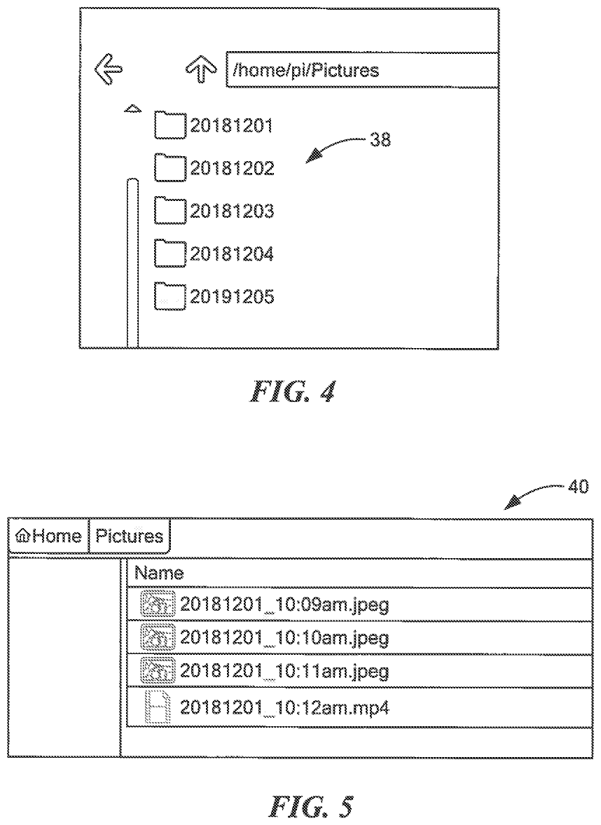

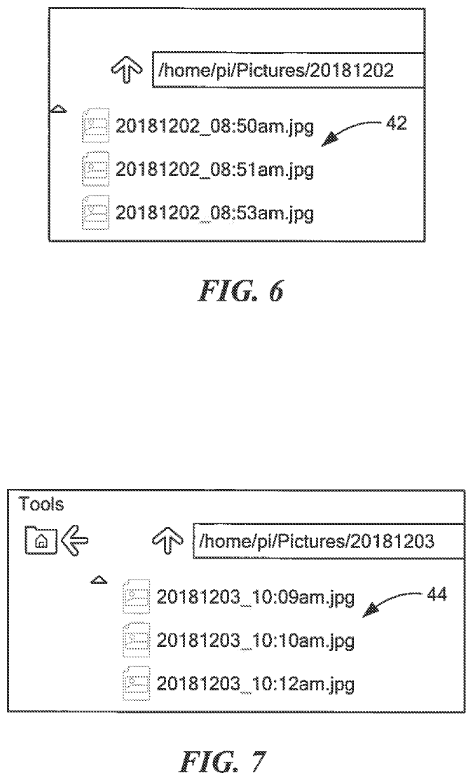

Computer subsystem 24 stores the captured images and/or videos of drivers while texting captured by law enforcement personnel 36 in law enforcement vehicle 17 on storage device 32 arranged by date and time. FIG. 4 show one example of subfolders 38 arranged by date and time. Each of the subfolders include captured images and/or videos of drivers while texting, e.g., the files indicated at 40, FIG. 5, indicated at 42, FIG. 6, and indicated at 4, FIG. 7. The captured image files and/or videos files of drivers while texting shown in this example in FIG. 4-7 are used to provide for ad-hoc transmission to a computer system of a law enforcement entity as discussed below.

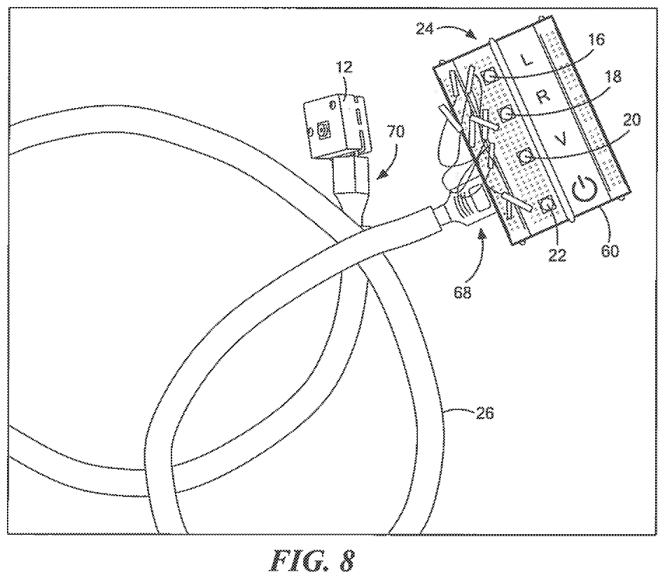

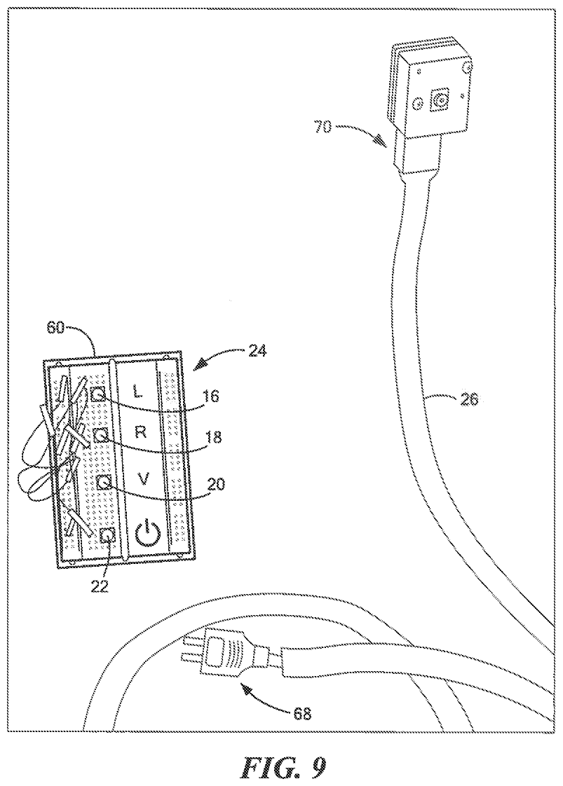

FIGS. 8 and 9 show examples of a prototype of one example of system 10 with dumb camera 12, user activated switches 16, 18, 20, and 22, computer subsystem 24, and an example of line 26 connected to dumb camera 12 and computer subsystem 20.

In one example, user activated switch 16 (L), FIGS. 1, 8, and 9, may be used to activate one or more dumb cameras located on one side of a law enforcement vehicle, e.g., dumb camera 12, FIG. 2, located on left or driver side 38, FIG. 2, of windshield 40 law enforcement vehicle 17 to enable dumb camera 12 to capture images and/or videos of drivers 34, FIG. 3, while texting located proximate left or driver side 38, FIG. 2, of law enforcement vehicle 17. Similarly, user activated switch 18 (R), may be used to activate one or mom dumb cameras located on another side of a law enforcement vehicle, e.g., dumb camera 14 located on right or passenger or right side 42 of windshield 40 of law enforcement vehicle 17 to enable dumb camera 14 to capture images and/or videos of drivers 34, FIG. 3, while texting proximate to left or passenger side 42 of law enforcement vehicle 17. As discussed above, the captured images are organized by date and time for ad-hoc transmission to a computer subsystem of a law enforcement entity.

User activated switch 20, FIGS. 1, 8, and 9, may be utilized to activate both dumb camera 12 located on left or driver side 38, FIG. 2, of law enforcement vehicle 17 and dumb cameral 14 located on right or passenger side 42 of law enforcement vehicle 17 as discussed above to enable dumb cameras 12 and 14 to capture video images of drivers while texting for a predetermined amount of time. In one example, the video captured by one or more dumb cameras 12, 14 is preferably constantly recording. The videos are preferably stored in cache memory of storage device 32 for about 10 seconds to allow law enforcement personnel to enable a “past tense” 10 second clip saved to storage device 32 in the event a driver has gone “past” the law enforcement personnel while texting and driving. The captured videos are similarly organized by date and time for ad-hoc transmission to a computer subsystem of a law enforcement entity as discussed above.

User activated switch 22 may be used to power system 10 on and off.

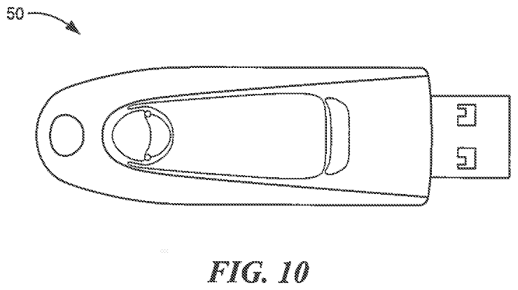

In one example, the ad-hoc transmission of the captured images and/or videos organized by date and time to the computer subsystem of a law enforcement entity may be provided with a portable storage device, e.g., flash drive 50, FIG. 10, or similar type storage device, by inserting the portage storage device into a port, e.g., a USB or similar type port, of computer subsystem 24, as discussed below. As disclosed herein, ad-hoc transmission is a local area network (LAN) that is built spontaneously as devices connect. Instead of relying on a base station to coordinate the flow of messages to each node in the network, the individual nodes forward packets to and from each other. An ad-hoc network is typically a decentralized type of wireless network and does not rely on preexisting infrastructure, such as routers in wired networks or access points in managed infrastructure wireless networks. Instead, each node participates in routing by forwarding data from other nodes, so the determination of which nodes forward the data is made dynamically on the basis of network connectivity and the routing algorithm used. Wireless, mobile ad-hoc networks are self-configuring, dynamic networks in which the nodes are free to move. See Wikepedia.com.

In another example, the ad-hoc transmission may be to a computer subsystem located in law enforcement vehicle 17, FIG. 2, by connecting a cable from computer subsystem 24 to the computer subsystem located in law enforcement vehicle 17. The ad-hoc transmission may also include Bluetooth and/or internal wireless transmission from computer subsystem 24 to the computer subsystem located in law enforcement vehicle 17.

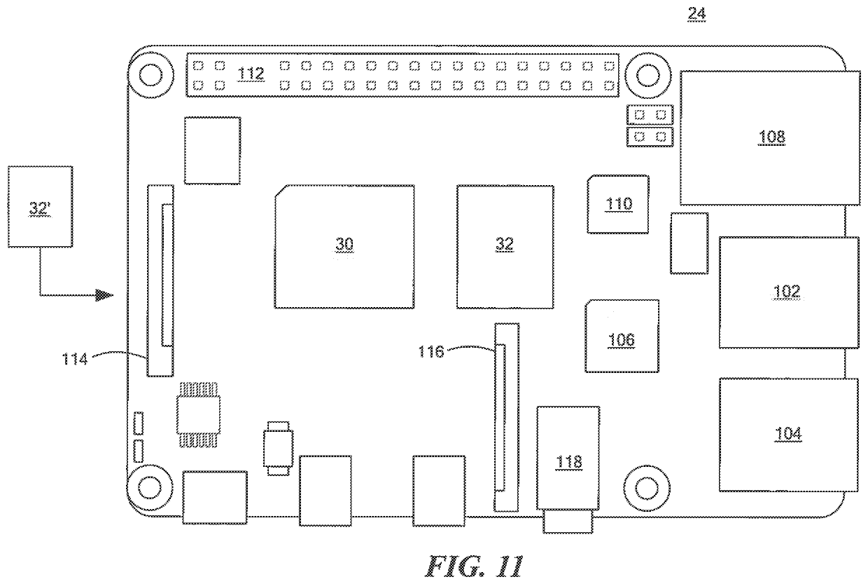

In one example, computer subsystem 24, FIGS. 1, 8, and 9, is preferably configured as a single board computer system, a micro-computer system(s), a miniature personal computer, a miniature personal computer board, and the like, e.g., a Raspberry Pi computer subsystem, which includes at least one or more processors 30, FIG. 1, and storage device 32. FIG. 11 show one example of the primary components of one example of computer subsystem 24 configured as a Raspberry Pi computer subsystem including one or more processors 30 and storage device 32. In this example, storage device 32 may include random access memory (RAM) 32 as shown and microSD storage device 32′ which may be inserted into a microSD storage slot on the back side of computer subsystem 24. In this example, computer subsystem also preferably includes USB ports 102, 104, USB controller 106, ethernet device 108, ethernet controller 110, 40 pin port 112, display serial interface (DSI) 114, camera serial interface adapter 116, and video and audio jack 118. In one design, computer subsystem 24 configured as a Raspberry Pi computer subsystem may be a model 0,0 W, 2,2B, 3B+3A or Pi 4, Rasberry Pi available from Sony UK Technology Centre, Pencoed Technology Park, Pencoed South Wales CF35 5 HZ. In one example, Raspberry Pi computer subsystem 24 includes one or more operating systems 58, FIG. 1, such as Linux, Unix, Raspian or similar type operating system.

Computer subsystem 24, FIGS. 1, 8, 9 and 11 coupled to dumb camera 12 by line 26 and/or dumb camera 14 by line 28 is preferably enclosed or housed in housing 60 as shown,

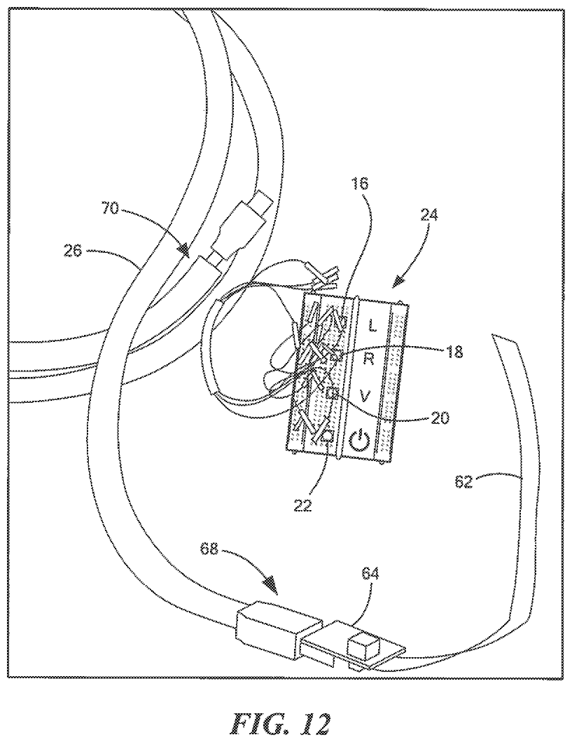

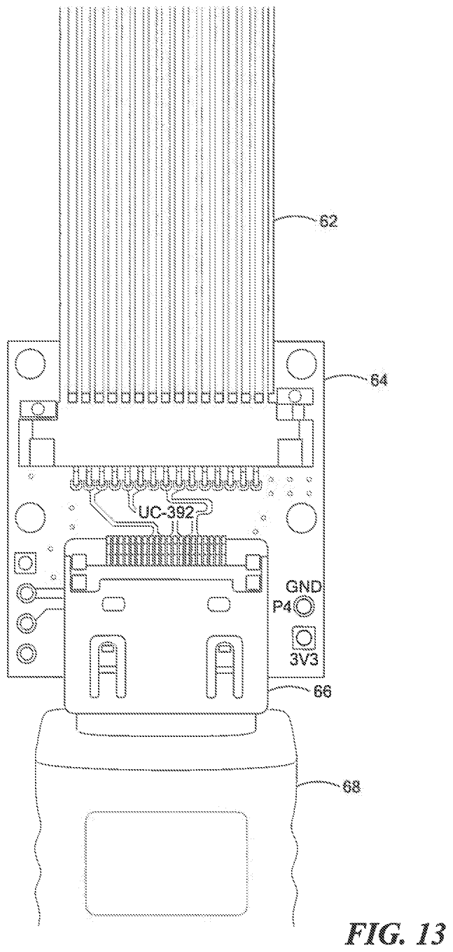

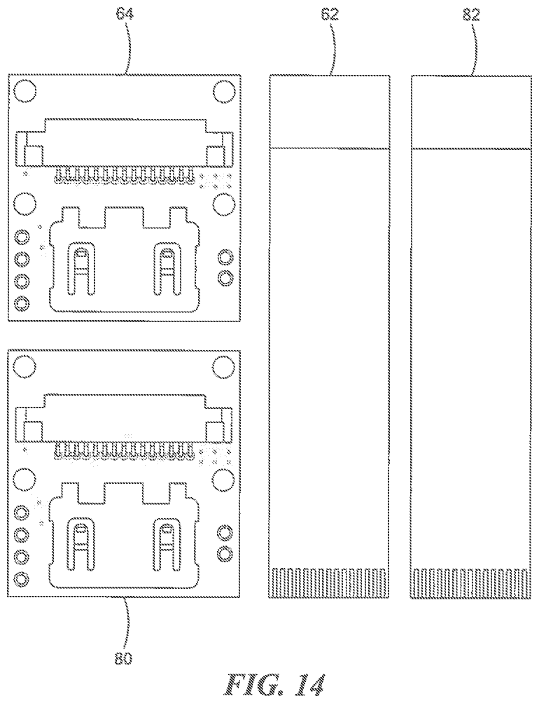

In one example, computer subsystem 24, FIGS. 1, 8, 9, and 11 may be coupled to line 26, e.g., an HDMI cable or similar type line, by first ribbon cable 62, FIGS. 12, 13, and 14, which is coupled to first HDMI ribbon adapter 64. In this design, first ribbon cable is preferably connected to camera serial interface adapter 116. First HDMI ribbon adapter 64 is preferably coupled to a HDMI plug of one end of HDMI cable, e.g., HDMI plug 66, FIG. 13, of end 68 of line HDMI cable 26. The other end of line 26 e.g., end 70, FIGS. 8, 9, and 12, preferably includes a second HDMI ribbon adapter, e.g., second HDMI ribbon adapter 80, FIG. 14 which is preferably coupled to end 70 of line 26. HDM ribbon adapter 80 is preferably coupled to second HDMI ribbon cable adapter 82. FIG. 14, which is preferably coupled to dumb cameral 12. In a similar manner, line 28, FIG. 1, is coupled computer subsystem 24 and dumb camera 14.

In other examples, one or more dumb cameras 12, 14 may be configured to with a USB connection and the end of HDMI cable 26 is appropriately adapted to accommodate one or more dumb cameras 12, 14 with a USB connection.

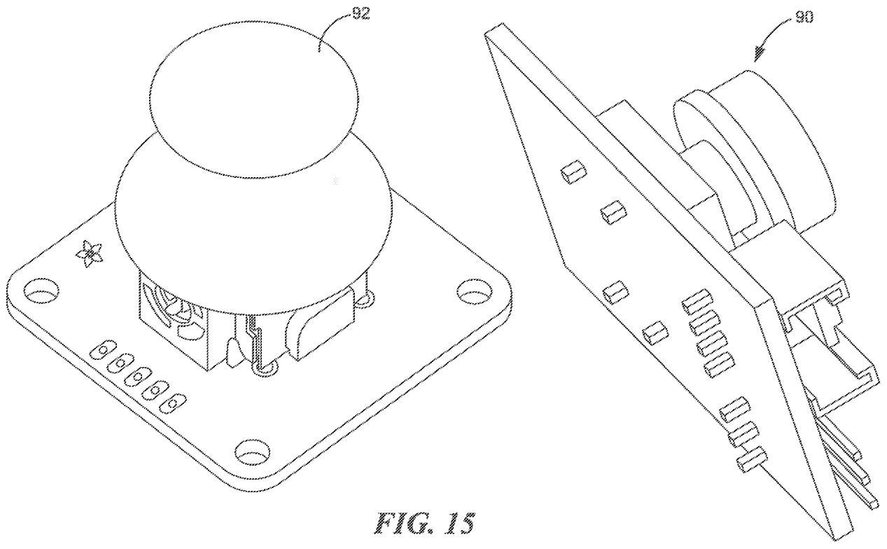

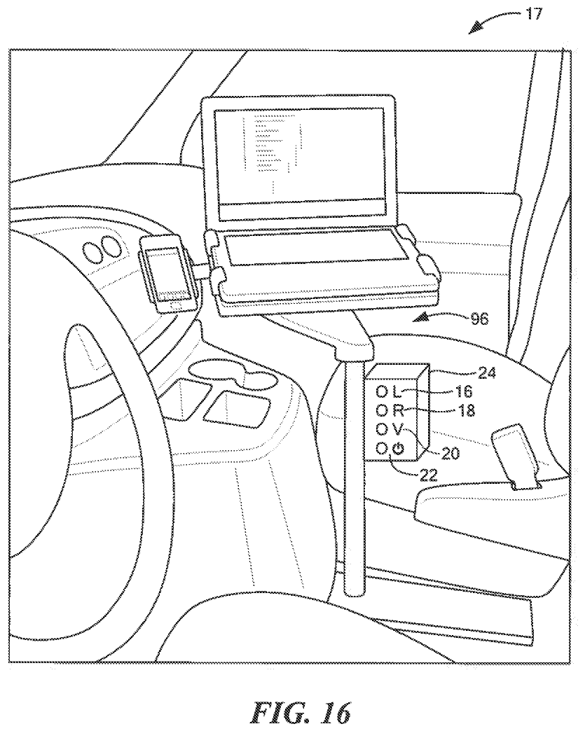

In one example, the plurality of user activated switches 16, 18, and 20, FIGS. 1, 8, 9 and 23, may include a toggle switch, e.g., toggle switch 90, FIG. 15. In another example, the one or more user activated switches 16,18 and/or 20 may include a joystick, e.g., joystick 92, FIG. 15, for controlling the view of one or more dumb cameras 12, 14. FIGS. 1, 8, 9 and 12.

In one example, computer subsystem 24, FIGS. 1, 8, 9 and 11, may be coupled to a computer mount located in a law enforcement vehicle, e.g., computer mount 96, FIG. 16, mounted in law enforcement vehicle 17 as shown.

For enablement purposes only, the following code portions are provided which can be executed on one or more processors, a computing device, or computer to carry out the primary steps and/or functions of self-contained, integrated ad-hoc transmission system 10 and method thereof for capturing images of drivers while texting by law enforcement personnel in a law enforcement vehicle discussed above with reference to one or more of FIGS. 1-16. Other equivalent algorithms and code can be designed by a software engineer and/or programmer skilled in the art using the information provided herein.

Function defbutton_press (Argument two, Argument Three, Argument
eight) {

Upon initializing button 2, button 3, or button 8; capture image
or video as

defined in a sorted and format stated on focal device or storage

Return to accepting state for next button initialize

End
)
In case of video button initialization, buttons 2 and 3 are recorded
together as video file
for full past tense video (10 seconds) and current state
End
}
Define

button = Button (2)

button = Button (3)
button = Button (8)
while True:

if button #2,3,8.is_pressed:
print(“Button is Pressed”)

else:

print(“Button is not Pressed”)

print defined as recording video of button 2, 3 simultaneously or
capture of camera on
button 2 or 3 individually as image

The result is system 10 and the method thereof safely and effectively enables law enforcement personnel inside a law enforcement vehicle to easily capture images or videos of drivers while texting and capture and store the captured images or videos by date and time to provide for safe ad-hoc transmission to a computer subsystem of a law enforcement entity. System 10 eliminates the need for networks, routers, and the like, is mounted inside a law enforcement vehicle, can only be utilized by law enforcement personnel, and provides a needed solution to law enforcement personnel provide citations to drivers that are texting while driving.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A self-contained, integrated ad-hoc transmission system for capturing images of drivers while texting by law enforcement personnel in a law enforcement vehicle, the system comprising:
one or more dumb cameras mounted inside the law enforcement vehicle;
a plurality of user-activated switches; and
a computer subsystem coupled to the one or more dumb cameras by one or more lines and coupled to a plurality of user-activated switches, the computer subsystem including at least one processor and a storage device configured to safely enable the law enforcement personnel inside the law enforcement vehicle to capture images and/or videos of drivers while texting by activating one of the plurality of user-activated switches to enable one or more of the one or more dumb cameras to capture the images and/or videos of drivers while texting, the processor further configured to store the captured images and/or videos on the storage device and organize the captured images and/or videos by date and time for ad-hoc transmission to a computer subsystem of a law enforcement entity.

2. The system of claim 1 in which the one or more dumb cameras mounted in the law enforcement vehicle includes at least one dumb camera mounted on a driver side of a law enforcement vehicle and at least one dumb camera mounted on a passenger side of a law enforcement vehicle.

3. The system of claim 2 in which the plurality of user-activated switches includes a first switch to enable the at least one dumb camera mounted on the driver side of the law enforcement vehicle to capture the images and/or videos of drivers while texting located proximate a driver side of the law enforcement vehicle and a second switch to enable the at least one dumb camera mounted on the passenger side of the windshield to capture the images and/or videos of drivers while texting proximate a passenger side of the law enforcement vehicle.

4. The system of claim 1 in which the ad-hoc transmission is to a portable storage device.

5. The system of claim 1 in which the ad-hoc transmission is to a computer subsystem located in the law enforcement vehicle.

6. The system of claim 1 in which the ad-hoc transmission includes one or more of Bluetooth or internal wireless transmission.

7. The system of claim 1 in which the computer subsystem is configured as one of: a single board computer system, a micro-computer system(s), a miniature personal computer, a miniature personal computer board.

8. The system of claim 7 in which the computer subsystem includes the one or more processors, the storage device, and an operating system.

9. The system of claim 8 in which the operating system includes one or more of Linux, and Unix, and Raspian.

10. The system of claim 7 in which the computer subsystem coupled to the one or more dumb cameras by the one or more lines includes the Raspberry Pi computer subsystem coupled to a first ribbon cable, the first ribbon cable coupled to a first HDMI ribbon adapter, the first HDMI ribbon adapter coupled to one end of an HDMI, a second HDMI ribbon adapter coupled to another end of the HDMI cable, and a second ribbon cable coupled to one of the one or more dumb cameras.

11. The system of claim 1 in which the one or more user-activated switches includes one or more a toggle switches.

12. The system of claim 1 in which the one or more user-activated switches includes one or more joysticks for controlling the view of the one or more dumb cameras.

13. The system of claim 1 in which the computer subsystem and the storage device are enclosed in housing and the plurality of user-activated switches are mounted on the housing.

14. The system of claim 13 in which the housing is coupled to a computer mount located in the law enforcement vehicle.

15. A method for capturing images of drivers while texting by law enforcement personnel in a law enforcement vehicle, the method comprising:
providing one or more dumb cameras mounted inside the law enforcement vehicle;
safely enabling law enforcement personnel located inside the law enforcement vehicle to capture images and/or videos of drivers while texting by activating one of a plurality of user-activated switches to enable one or more of the one or more dumb cameras to capture the images and/or videos of drivers while texting;
storing the captured images and/or videos on a storage device; and organizing the captured images and/or videos by date and time for ad-hoc transmission to a computer subsystem of a law enforcement entity.

16. The method of claim 15 further including mounting at least one or more of the dumb cameras on a driver side of the law enforcement vehicle and mounting at least one dumb camera on a passenger side of the law enforcement vehicle.

17. The method of claim 16 in which the at least one or more dumb cameras mounted on the driver side of the law enforcement vehicle enables capturing of images and/or videos of drivers while texting located proximate the driver side of the law enforcement vehicle and enabling at least one or more dumb cameras located on the passenger side of the law enforcement vehicle enables capturing images and/or videos of drivers while texting proximate the passenger of the law enforcement vehicle.

18. The method of claim 15 in which the ad-hoc transmission is provided by a portable storage device.

19. The method of claim 15 in which the ad-hoc transmission is provided to a computer subsystem located in a law enforcement vehicle.

20. The method of claim 15 in which the ad-hoc transmission includes one or more of Bluetooth or internal wireless transmission.
